(19) United States
(12) Patent Application Publication
(10) Pub. No.: US 2022/0173521 A1
(43) Pub. Date: Jun. 2, 2022

(54) TELECOMMUNICATION SIGNAL RANGE ENHANCEMENT USING PANEL REFLECTANCE

(71) Applicant: DuPont Electronics, Inc., Wilmington, DE (US)

(72) Inventors: Wei Wu, Hockessin, DE (US); Gregory Scott Blackman, Media, PA (US); Jonathan Andrew Weldon, Houston, TX (US)

(21) Appl. No.: 17/109,271

(22) Filed: Dec. 2, 2020

(51) Int. Cl. H01Q 15/14; H01B 11/18; H01Q 3/46

(52) U.S. Cl. CPC H01Q 15/14; H01Q 3/46; H01B 11/1821

(57) ABSTRACT

A panel to enhance telecommunication signal range includes a base sheet. A reflector on a side of the base sheet reflects a telecommunication signal that is of a predetermined wavelength and that is incident on the base sheet. A reflected telecommunication signal is reflected in a predetermined direction, and the attenuation loss in the reflected telecommunication signal is less than a predetermined threshold. Methods to manufacture such panels are also described.

### BACKGROUND

The present invention relates in general to construction panels and a method of manufacturing the same, and more specifically, the present invention relates to a construction panel that enhances range of telecommunication signal inside buildings that use the construction panel.

We are increasingly depending on telecommunication networks. Telecommunications networks have prevalently become wireless. Such wireless telecommunication uses electromagnetic waves in general, and microwave and millimeter-waves in particular, for example, 5G networks. As the frequency increases the attenuation of the signal becomes more pronounced. It is a significant challenge to maintain signal strength within the built environment. Progress in the technology of telecommunications networks includes increases in bandwidth and download speeds. Due to such improvements, it is expected that telecommunications networks will not just serve cellphones like existing cellular networks but will also be used for internet service for computing systems like, laptops and desktop computers. Further, telecommunications networks facilitate new applications in internet of things (IoT) and machine to machine areas.

### SUMMARY

According to one or more embodiments of the present invention, a panel includes a base sheet. A reflector on a side of the base sheet reflects a telecommunication signal that is of a predetermined wavelength and that is incident on the base sheet. A reflected telecommunication signal is reflected in a predetermined direction, and the attenuation loss in the reflected telecommunication signal is less than a predetermined threshold.

The telecommunication signal is a 5G signal. The telecommunication signal is incident on a first side of the base sheet, and the reflector is on a second side of the base sheet, the second side being opposite to the first side. the opposite side is facing a target area to which the telecommunication signal is to be directed.

In one or more embodiments of the present invention, the reflector includes multiple reflectors.

In one or more embodiments of the present invention, the reflector is made of an array of metallized patterns that are directly printed on a surface covering.

In one or more embodiments of the present invention, the reflector is made of an array of metallized patterns that is printed on a flexible substrate, which is laminated on a surface covering.

In one or more embodiments of the present invention, reflector is a passive reflector that does not require a power source.

In one or more embodiments of the present invention, the reflector is coupled with the base sheet. The reflector is coupled with the base sheet by laminating the reflector on the base sheet.

In one or more embodiments of the present invention, the positions and number of reflectors are determined based on an environment in which the panel is located. The positions are determined based on a location of a telecommunication antenna that provides the telecommunication signal that is incident on the reflectors. Further, the positions are based on a location of a computing device that receives the telecommunication signal from the reflectors.

In one or more embodiments of the present invention, the positions and number of reflectors are determined based on an environment in which the panel is located. The positions are determined based on a location of a telecommunication antenna that provides the telecommunication signal that is incident on the reflectors. Further, the positions are based on a predetermined location/area in the environment where the strength of the telecommunication signal is below a predetermined location.

In one or more embodiments of the present invention, the panel further includes a controller coupled with the reflector. The controller performs a method in which, in response to a user touching the reflector with a predetermined object, coordinates of a position at which the object touches the reflector are determined. The coordinates are in a frame of reference of the reflector. The method further includes outputting the coordinates that are determined.

According to one or more embodiments of the present invention, a method to manufacture a panel includes manufacturing a construction panel and screen-printing a reflector on one side of the construction panel. The reflector is made using a material that has at least a predetermined reflectance and at most a predetermined absorption of the telecommunication signal.

In one or more embodiments of the present invention, the method further includes screen-printing a plurality of wired filaments on the construction panel, the wired filaments connecting the reflector to a controller.

In one or more embodiments of the present invention, the method further includes, coupling the controller to the construction panel.

According to one or more embodiments of the present invention, a method to manufacture a panel includes forming, on a substrate film, one or more reflectors. The one or more reflectors include metallized patterns, and the substrate is made from a material has at most a predetermined absorption of the telecommunication signal. The method further includes laminating the substrate film on a construction panel.

In one or more embodiments of the present invention, the reflectors are formed using etching. Alternatively, in one or more embodiments of the present invention, the one or more reflectors are printed on the substrate film to form the metallized patterns.

In one or more embodiments of the present invention, the substrate film is laminated on a first side of the construction panel, wherein a telecommunication signal is expected to be incident on a second side that is opposite to the first side.

Additional features and advantages are realized through the techniques described herein. Other embodiments and aspects of the invention are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts a block diagram of a system that facilitates wireless communication inside buildings by using reflection panels to enhance range of telecommunication signal according to one or more embodiments of the invention;

FIG. 2 depicts a block diagram of a structure of a reflection panel according to one or more embodiments of the invention;

FIG. 3 depicts a block diagram of a structure of a reflection panel according to one or more embodiments of the invention;

FIG. 4 depicts a block diagram of a structure of a reflection panel according to one or more embodiments of the invention;

FIG. 5 depicts a block diagram of a structure of a reflection panel according to one or more embodiments of the invention;

FIG. 6 depicts a block diagram of a structure of a reflection panel according to one or more embodiments of the invention;

FIG. 7 depicts a block diagram of a structure of a reflection panel according to one or more embodiments of the invention;

FIG. 8 depicts a block diagram of a structure of a construction panel that facilitates user-interaction according to one or more embodiments of the invention;

FIG. 9 depicts a flowchart for a method of manufacturing a construction panel according to one or more embodiments of the invention; and

FIG. 10 depicts a flowchart for a method of manufacturing a construction panel according to one or more embodiments of the invention.

It should be noted that the drawings herein may not be to scale. In the accompanying figures and following detailed description of the disclosed embodiments of the invention, the various elements illustrated in the figures are provided with two, three, or four-digit reference numbers. In most instances, the leftmost digit(s) of each reference number corresponds to the figure in which its element is first illustrated.

### DETAILED DESCRIPTION

For the sake of brevity, conventional techniques related to making and using aspects of the invention may or may not be described in detail herein. In particular, various aspects of the materials, structures, computing systems, and specific computer programs to implement the various technical features described herein are well known. Accordingly, in the interest of brevity, many conventional implementation details are only mentioned briefly herein or are omitted entirely without providing the well-known system and/or process details.

For wireless telecommunications networks, and in particular microwave or millimeter-wave communication systems, establishing a wireless link between a first network node (e.g., antenna) that is outdoors from or at the periphery of a building, and a second network node (e.g., client device) that is indoors, can be difficult. Typically, such connections suffer a significant loss in power when propagating through an environment, such as an indoors environment, because of walls, windows, furniture, and other such surfaces and objects. In some cases, the loss in power can occur even when propagating the telecommunication signal between two antennas, both antennas being outdoor or indoor, because of absorption of the telecommunication signal by the objects in the propagation path. Fifth Generation (5G) systems, which are expected to enable a higher utilization capacity than current wireless systems, permitting a greater density of wireless users, with a lower latency are expected to transmit and receive in the Gigahertz band. For example, “Low-band 5G” and “Mid-band 5G” use frequencies from 600 Megahertz (MHz) to 6 Gigahertz (GHz). “High-band 5G” can use frequencies from 3.1 GHz to 5.0 GHz “Very High-band 5G” can use frequencies from 24 GHz to 44 GHz. It should be noted that particular bands within these ranges can be used for specific applications, geographies, network providers, etc., and that additional frequency ranges from those provided above may be used. A signal at a frequency of 44 GHz has a wavelength of 6.8 mm, hence some 5G signals are alternatively known as the millimeter wave (“mmWave”) spectrum.

5G signals, however, have limited penetration through surfaces and objects. In present wireless systems that do not use 5G, the typical distance between adjacent antennas is about 1.5-3.2 kilometers (km). In contrast, for proposed advanced wireless systems, such as 5G systems, the distance between adjacent antennas may need to be reduced to about 200-300 meters. Therefore, next generation wireless systems may need as many as one hundred times the number of antennas as compared to current wireless systems. In other words, effective use of 5G frequencies for the telecommunications networks requires a greater cell density of communication nodes, relative to present systems.

Modern construction panels, such as drywall, glass, wood, Styrofoam, and other panels used for walls in buildings, etc., can attenuate radio frequency (RF) signals, thereby, limiting the range of communication nodes located in or near such buildings that use the 5G spectrum. Accordingly, technical challenges exist to communicatively link a wireless device, such as a customer premise equipment (CPE), with telecommunication network nodes, such as antennas, and limiting the propagation loss in such communication. The telecommunication network nodes can be indoors or outdoors. In 5G communications, the signals mostly rely on a line-of-sight propagation instead of the diffraction for 4G and earlier generation communication systems. For signal propagation, most of the high frequency signals may be blocked by surfaces such as walls, roofs, floors, appliances, furniture, etc. In addition, human body also blocks the 5G signals significantly.

Embodiments of the invention described herein address the above-described attenuation loss shortcomings and technical challenges in wireless telecommunications networks by providing a reflection panel having an array of reflectors configured and arranged to improve the high frequency signal's line-of-sight distance and reflectance of the reflecting surface of the reflecting panel from which a telecommunications signal is reflected to a target area. In accordance with aspects of the invention, the reflector can be made of from a material having a high reflectance in the 5G frequency range. High reflectance in RF frequency is associated to a high electrical conductivity of the reflector material. Here, a material with “high reflectance” can be any material that, for a signal in the 5G frequency range, has a conductivity of at least a predetermined threshold such as 10000 Siemens/meter (S/m). In some embodiments of the invention, the reflector 210 can be covered by a substrate with “low absorption,” which can be made of a material that, for a signal in the 5G frequency range, has an absorption below a predetermined threshold, such as 0.1 decibel/millimeter. The substrate is not relatively transparent in the 5G range, allowing the telecommunication signal to pass through to the reflector, which in turn causes the reflected telecommunication signal to be directed to a CPE in a target area. The target area can be indoors, outdoors, or a combination thereof. The improved reflectance induced by the array of reflectors reduces the attenuation loss, and in turn, improves the strength of a telecommunication signal that travels between a CPE and an antenna. Exemplary embodiments of the invention described herein facilitate making and using a panel that enhances the propagation in the communication signal between the CPE and wireless antennas. The panel in the embodiments of the invention described herein can further provide advantages such as those noted regarding a touch interactive panel, a decorative item, a screen, and such.

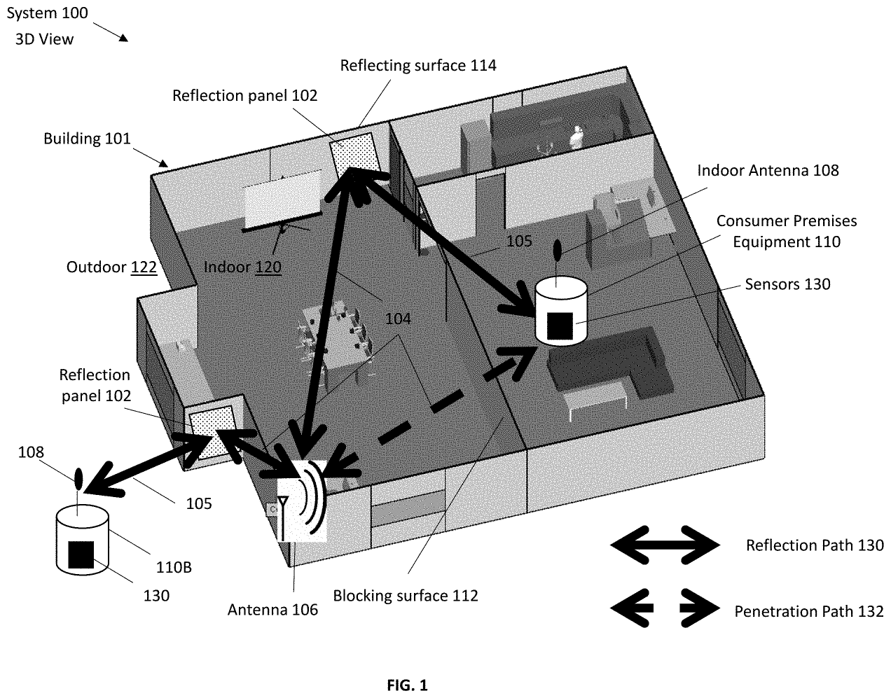

FIG. 1 depicts a block diagram of a system 100 that facilitates wireless communication in a target area in accordance with embodiments of the invention. The system 100 includes reflection panels 102, antennas 106, 108, and one or more CPEs 110. The reflection panels 102 are configured and arranged to enhance range of telecommunication signal in the vicinity of a building 101 using reflectance according to one or more embodiments of the invention. In the three-dimensional (3D) view of the building 101 having the system 100 integrated therewith, the building 101 separates the indoors 120 from the outdoors 122. The building 101 can be an office building, a single-family house, a multi-family dwelling, a shop, a mall, airport, train station, bus station, parking garage, entertainment arena, sports arena, warehouse, or any other type of building.

A wireless telecommunications network, such as a 5G network, facilitates a CPE 110 to communicate with servers (not shown), other CPEs, and other devices, for example, using the Internet, cellular network, short messaging service, etc. Such communication is facilitated by at least one antenna 106 sending and receiving data to/from the CPE 110. The CPE 110 can include an antenna 108 that facilitates sending/receiving data by the CPE 110. The antenna 106 sends/receives data to/from the antenna 108 using a telecommunication signal 104 (“signal”). It should be noted that the antenna 106 is depicted indoors in FIG. 1, however, the antenna 106 can be outdoors in other embodiments. The signal 104 can be an electromagnetic or radio wave in the spectrum of frequencies used by the wireless telecommunications networks. For example, the signal 104 can be in the 5G spectrum of frequencies.

The antenna 106 can be a single antenna, an array of antennas, a cell tower, or any other device that transmits the signal 104 to the CPE 110. The CPE 110 can be any communication device, such as a computing device, phone, tablet, router, modem, television, sensor array, medical device, appliance, industrial device, or any other device that facilitates sending and receiving data using the signal 104. The CPE 110 can also include one or more sensors 130. For example, the CPE 110 can include temperature sensors, pressure sensors, motion sensors, proximity sensors, smoke sensors, infrared sensors, optical sensors, humidity sensors, gas sensors, water quality sensors, gyroscopic sensors, acceleration sensors, or any other type of sensors. The CPE 110 can send measurement(s) from the one or more sensors 130 using the telecommunication signal 104. Alternatively, or in addition, the CPE 110 can receive instructions to use the one or more sensors 130 for specific measurement(s) using the telecommunication signal 104. It should be noted that although the CPE 110 is depicted as a stand-alone device in FIG. 1, the CPE 110 can be integrated in one or more objects in the environment, for example, in furniture, décor items, walls, doors, windows, appliances, or any other items that are indoor 120 and/or outdoor 122.

It should be noted that the CPE 110 can be indoor 120 and/or outdoor 122. The reflection panel 102 can be indoor 120 and/or outdoor 122. In an example, the reflection panel 102 can be part of a roof, floor, wall, window, door, or any other part of a building. The reflection panel 102 can reflect the telecommunication signal 104 from the antenna 106 to a target area that is predicted to include the CPE(s) 110. In the depicted example scenario of FIG. 1, the target area of the reflection panel 102 that is shown indoor 120 includes the CPE 110, while the target area of the reflection panel 102 that is outdoor 122 includes another CPE 110B. It is understood that the positioning of the reflection panels 102 shown in FIG. 1 is exemplary, and that in other embodiments of the invention, the reflection panels 102 can be positioned elsewhere. It is also understood that in other embodiments of the invention there can be a different number of reflection panels 102, CPEs, and other components, than those depicted in FIG. 1.

The telecommunication signal 104 travels through the environment of the indoors 120 between the antenna 106 and the CPE 110, with such travel including penetration through one or more surfaces (e.g., blocking surface 112) and reflection from one or more surfaces (e.g., surface 114). Although the telecommunication signal 104 can take several different paths to the CPE 110, in the FIG. 1 a reflection path 130 and a penetration path 132 are depicted. The penetration path 132 includes the telecommunication signal 104 traveling through the blocking surface 112. The reflection path 130 includes the telecommunication signal 104 reflecting off of the reflection panel 102 as a reflected signal 105 (caused by the reflection) traveling to the CPE 110. The reflected signal 105 is shown to travel through an opening, such as door, passage, etc., in the blocking surface 112 to reach the CPE 110.

It is understood that in other examples, a path can include additional penetrations and reflections. Also, a path can include a combination of reflection, penetration, and other modes of travel. Further, in FIG. 1 the penetration occurs at a blocking surface 112 that is depicted as a wall, however, in other cases, the penetration can occur at other blocking surfaces 112, such as furniture, screens, appliances, décor items, and other such items. Also, the reflection in FIG. 1 is depicted to occur at another wall (e.g. another reflecting surface 114), however, in other cases, the reflection can occur at other reflecting surfaces 114, such as furniture, screens, appliances, décor items, and other such items. Such travel paths (130, 132) of the telecommunication signal 104 can be determined by mapping the environment (indoor 120 and/or outdoor 122) using software tools.

The reflecting surface 114 can include the reflection panel 102 as a coating, such as a metallic film, a polarization film, a privacy film, a thermal film, a decorative film, and other such applications or a combination thereof for improving a comfort level and/or décor of the target area. Such coatings can be applied to the reflection panel 102 after manufacturing the reflecting surface. Alternatively, or in addition, such films, and the material can be incorporated in the reflecting surface 114 at the time of manufacture of the reflecting surface 114. The reflection panel 102 can inhibit penetration and/or reflection of the signal 104. Therefore, the reflection panel 102 can cause an attenuation loss in the telecommunication signal 104. Embodiments of the invention described herein address such technical challenges regarding the attenuation loss in a telecommunication signal caused by one or more surfaces in the path of the telecommunication signal. Embodiments of the invention herein address the technical challenges by providing a reflection panel 102 that improves the reflectance/reflectivity of the surfaces from which the telecommunication signal 104 reflects. The reflection panel 102 changes the reflectance of the surface on which the telecommunication signal 104 is incident, or is predicted to be incident, as described herein. The improved reflectance reduces the attenuation loss, and in turn, improves the strength of the telecommunication signal 104 that travels between the CPE 110 and the antenna 106.

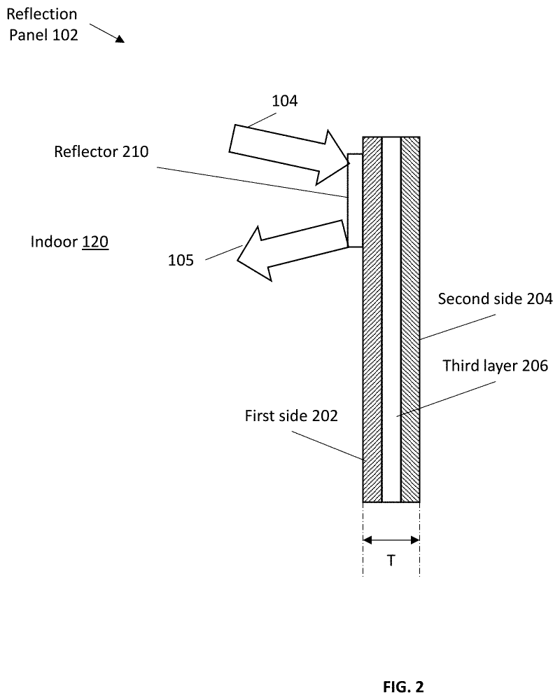

FIG. 2 depicts a block diagram of a structure of the reflection panel according to one or more embodiments of the invention. The reflection panel 102 can be a construction panel, such as drywall, wood, sandwich panel, glass, low emittance (low-E) insulated glass, or any other type of panel that is used to build walls or other partitioning surfaces. Alternatively, or in addition, the reflection panel 102 can be a surface of a screen (e.g., projector screen), a painting, a canvas, an appliance, or any other such object. The reflection panel 102 can be made of glass, aluminum, fiber cement, ultra-high-performance concrete (UHPC), or any other natural or man-made material(s). It should be noted that the reflection panel 102 can include any type of panel from those exemplified herein or any other type of panel.

The reflection panel 102 includes a first side 202 on which the telecommunication signal 104 is incident upon. In other words, the first side 202 refers to the side that faces the target area. In one or more examples, the first side 202 can include dielectric material, such as porcelain (ceramic), mica, glass, plastics, and the oxides of various metals. The reflection panel 102 further includes a second side 204, which is opposite to the first side 202. In other words, the second side 202 refers to the side of the reflection panel 102 on which the telecommunication signal 104 is not incident upon.

In one or more examples, a third layer 206 is between the first side 202 and the second side 204. For example, the reflection panel 102 is a vacuum-insulated glass (VIG) with the third layer 206 being an evacuated space (i.e., vacuum) located between the first side 202 and the second side 204. Alternatively, the third layer 206 is polyethylene (PE), polyurethane (PU), polystyrene foam insulation, or a mix of low-density polyethylene and mineral material. In other examples, the third layer 206 can be made of other material than the examples described herein.

In some examples, the reflection panel 102 includes additional layers (not shown) that are between the first side 202 and the second side 204. In some examples, the wavelength of the telecommunication signal 104 is more than a thickness (T) of the reflection panel 102.

The reflection panel 102 includes a reflector 210 that causes the telecommunication signal 104 to reflect, resulting in reflected telecommunication signal 105. In accordance with aspects of the invention, the reflector 210 can be made of from a material having a high reflectance in the 5G frequency range. High reflectance in RF frequency is associated to a high conductivity of the reflector material. Here, a material with “high reflectance” can be any material that, for a signal in the 5G frequency range, has a conductivity of at least a predetermined threshold such as 10000 Siemens/meter (S/m). Further, the reflector 210 can be covered by a substrate with “low absorption,” which can be made of a material that, for a signal in the 5G frequency range, has an absorption below a predetermined threshold, such as 0.1 decibel/millimeter. The substrate is not reflective, allowing the telecommunication signal 104 to pass through to the reflector 210, which in turn causes the reflected telecommunication signal 105 to be directed to the CPE 110. It is understood that the above threshold values are exemplary, and that other threshold values can be used in other embodiments of the present invention. In some embodiments of the invention, a suitable material for the reflector 210 can include a metallic coated antenna on top of a thin-film material sold under the trade name Tedlar™ wallcoverings. In some embodiments of the invention, a suitable material for the reflector 210 can be metallic coated antenna on a combination of Tedlar®/polyethylene terephthalate (PET). In one or more examples, as shown in FIG. 2, the reflector 210 is on the first side 202 of the reflection panel 102. The reflector 210 can cover the first side 202 partially, in an example. Alternatively, the reflector 210 covers the entire first side 202. 210 can also be an array of reflective antennas coated on the Tedlar™ wallcoverings. It should be noted that, in some examples, the number of reflectors 210 can vary from those depicted in the drawings herein.

In an example, a reflector 210 is laminated on the reflection panel 102. In one or more embodiments of the invention, a laminated sheet can be made of a flexible substrate on which the reflector(s) 210 are etched or printed. The laminated sheet can be manufactured using at least one substrate of Tyvek®, Tensylon®, PET, and Polycarbonate. All these substrates have a low absorption for the telecommunication signal 104, which can be a 5G signal.

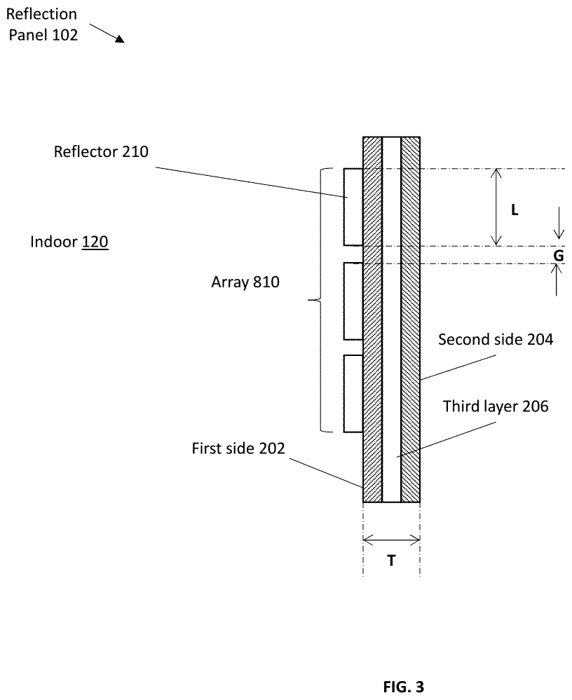

FIG. 3 depicts a block diagram of another structure of the reflection panel according to one or more embodiments of the invention. In the structure depicted in FIG. 3, the first side 202 includes an array 810 of reflectors 210. The increased number of reflectors adds more directional focus and control freedom towards the desired signal improving locations.

It should be noted, that although drawings herein depict the reflector(s) 210 to be protruding from the surfaces of the reflection panel 102, the reflector(s) 210 can be inset or substantially flat with the surfaces in one or more embodiments of the invention. It is understood that the drawings herein are not to scale, and that components are depicted larger/smaller than actual implementation. In the implementations, the thickness of each, the reflectors 210, and the substrate, is less than 1 centimeter. In one or more embodiments of the present invention, the width (depth) of the reflector(s) 210 is an integer multiple of the half-wavelength of the telecommunication signal 104. The reflector 210 can have a square shape, a circular shape, a rectangular shape, a diamond shape, or any other shape. To optimize/maximize the interaction between the telecommunication signal 104 and the reflector(s) 210, the dimensions of the reflector(s) 210 are based on the half-wavelength and on the shape used. For example, if the reflector(s) 210 is square-shaped, each side can be an integer multiple of the half-wavelength of the telecommunication signal 104.

For example, in the case where the telecommunication signal 104 is of the frequency 28 GHz, the reflector 210 can be a square with each side being of length L=5.35 millimeter, and a distance between each reflector can be G=0.5 millimeter. The values of L and G can be varied based on the expected frequency used by the telecommunication signal 104. Further, it is understood that the above values are examples, and that the L, G, and frequency of the telecommunication signal 104 can be different in other embodiments of the invention. Further yet, the number of reflectors 210 in the reflection panel 102 can vary based on the size of the reflection panel 102 that is applied to the surface. For example, the reflection panel 102 can include reflectors 210 arranged as a matrix of size 10×10, 10×20, 10000×10000, or any other dimension.

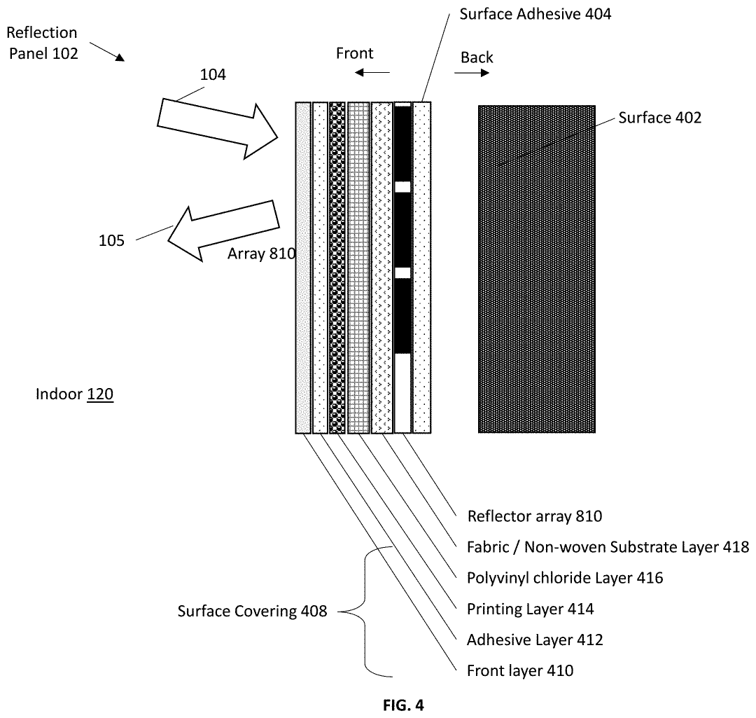

FIG. 4 depicts a block diagram of another structure of the reflection panel according to one or more embodiments of the invention. In the structure depicted in FIG. 4, the reflectors 210 are part of a surface covering 408 that is added to a surface 402 such that the surface covering 408 faces the target area. The surface 402 can be of any surface, such as a wall, a furniture surface, a screen, a décor item, a door, a window, an appliance, or any other such surface. The surface 402 can be made of any material, such as drywall, glass, or any other material. The surface 402 can include any wall or window and any decorative hanging, furniture, table, etc. The surface covering 408 is added to the surface 402 using a surface adhesive 404. For example, the adhesive 404 facilitates laminating the surface covering 408408 on to the surface 402. In an example, the adhesive 404 is part of the surface covering 408 itself. Further, the surface covering 408 includes the reflector(s) 210.

FIG. 4 also shows an expanded view of the layers in the surface covering 408 according to one or more embodiments of the present invention. The surface covering 408 can include multiple layers such as an adhesive layer, a graphics/aesthetics layer, a poly vinyl chloride (PVC) layer, a fabric or non-woven material layer, a low-absorption layer, etc. Several possible layering orders are now described; however, the ordering of the layers can vary in other embodiments.

In an embodiment of the invention shown in FIG. 4, the surface covering 408 includes a front layer 410 that is made of a low-absorption, durable, and easy to clean material, such as Tedlar®. The front layer 410 can be optically transparent in one or more embodiments of the present invention. The front layer 410 is the layer of the surface covering 408 that faces the target area of the reflection panel 102.

The surface covering 408 further includes an adhesive layer 412. The adhesive layer 412 binds the front layer 410 to a printing layer 414 of the surface covering 408. The printing layer 414 can facilitate the surface covering 408 to include a decorative or aesthetic pattern/look or color.

Further layers include a PVC layer 416 and a fabric or non-woven substrate layer 418. The PVC layer 416 can provide mechanical impact resistance/buffer, moisture resistance, thermal insulation, and/or other functions, to the surface 402. In one or more embodiments of the present invention, the reflector array 810, which includes multiple reflectors 210, is formed on the “back” side of the fabric/non-woven substrate layer 418 using screen-printing, plating, milling, lithography, or any other additive or subtractive manufacturing techniques.

The layers of the surface covering 408 do not interfere with the telecommunication signal 104, i.e., the strength of the telecommunication signal 104 is reduced by at most a predetermined value by the surface covering 408.

In one or more embodiments of the present invention, the surface covering 408 is adhered to the surface 402 using a surface adhesive 404. In an example, the surface adhesive 404 may be part of the surface covering 408 to facilitate the surface covering 408 to be laminated onto the surface 402. Alternatively, the surface adhesive 404 is externally applied to the surface 402 or the surface covering 408 prior to adhering the surface covering 408 to the surface 402. The reflectors 210, in this case, are supported by the surface 402.

In one or more embodiments of the present invention, the reflectors 210, instead of being formed on the fabric/non-woven substrate layer 418, are adhered to the substrate layer 418, or to the surface 402, and the surface covering 408 is applied on top of the reflectors 210.

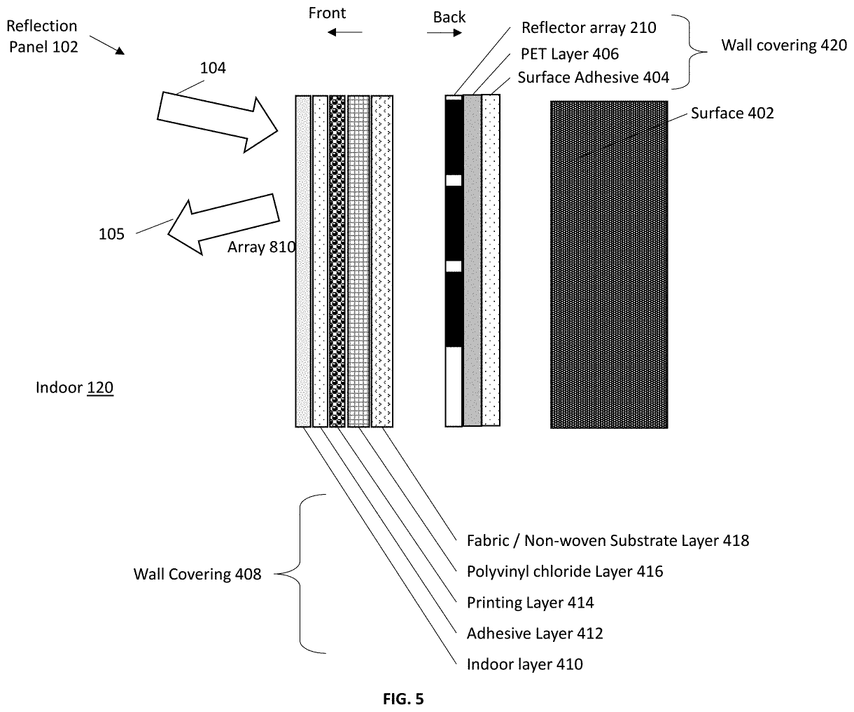

FIG. 5 depicts a block diagram of another structure of the reflection panel according to one or more embodiments of the invention. Here, the reflectors 210 are added between the surface covering 408 and the surface 402 using a second surface covering 420. The second surface covering can include a polyethylene terephthalate (PET) layer 406. The reflector array 810 can be formed on the “front” side of the PET layer 406, for example, using screen-printing, plating, milling, lithography, or any other additive or subtractive manufacturing techniques. The second surface covering 420 is adhered to the surface 402 using an adhesive layer 404. Alternatively, or in addition, the adhesive layer 404 is externally applied to the surface 402 or to the second surface covering 420. The (first) surface covering 408 is applied on the front side of the second surface covering 420. The adhesive layer 404 can facilitate fixing both the surface coverings 408, 420 to the surface 402 in one or more embodiments of the present invention. Alternatively, another adhesive layer can be applied to the back side of the fabric/non-woven substrate layer 418 and/or to the front side of the reflectors 210 to fix the first surface covering 408 to the second surface covering 420.

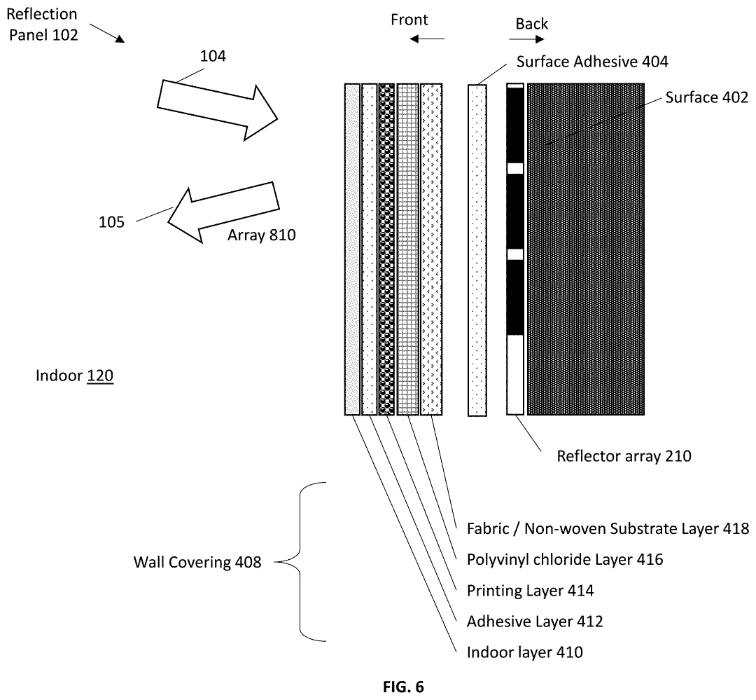

FIG. 6 depicts a block diagram of another structure of the reflection panel according to one or more embodiments of the invention. Here, the reflectors 210 are formed on the surface 402. The surface covering 408 covers and protects the reflectors 210, without interfering with the telecommunication signal 104 reaching the reflectors 210. The surface covering 408 is fixed to the surface 402 using the adhesive layer 404. The adhesive layer 404 can be part of the surface covering 408 in one or more embodiments of the present invention. Alternatively, the adhesive layer 404 is external to the surface covering 408. The reflectors 210 are formed on the surface 402, for example, using screen-printing, plating, milling, lithography, or any other additive or subtractive manufacturing techniques.

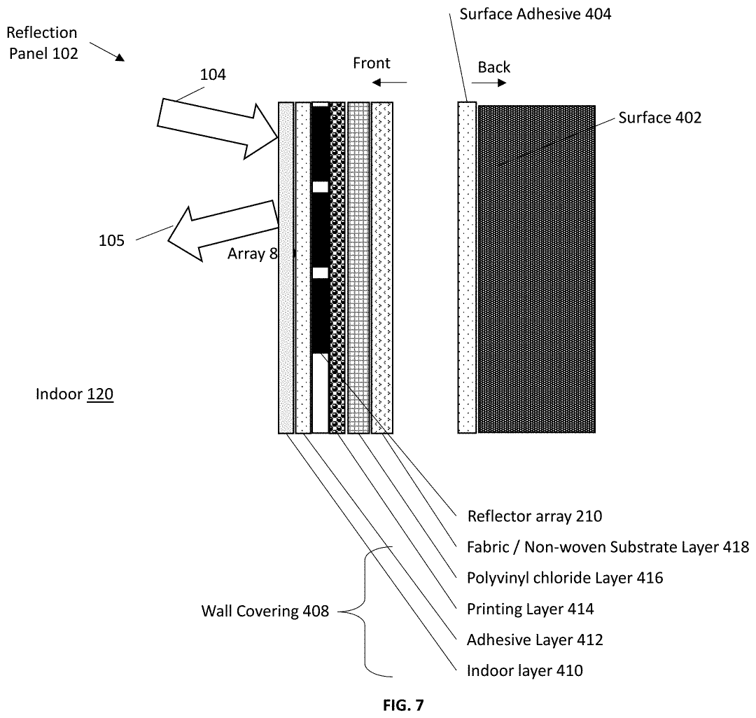

FIG. 7 depicts a block diagram of another structure of the reflection panel according to one or more embodiments of the invention. In one or more embodiments of the present invention, the reflectors 210 are formed on the front side of the printing layer 414. In this embodiment the printing layer 414 is made of non-conductive graphic print inks by inkjet printing or flexographic or gravure or rotary screen printing. In one or more embodiments of the present invention, the reflectors 210 are formed on the printing layer 414 using screen-printing, plating, milling, lithography, or any other additive or subtractive manufacturing techniques. The surface covering 408, with the reflectors 210 included on the printing layer 414, is applied to the surface 402 using the adhesive 404.

In one or more embodiments of the present invention, the reflector(s) 210 reflect the telecommunication signal 104 that is of a predetermined wavelength and that is incident on the reflection panel 102. The reflected telecommunication signal 105 that is caused is reflected in a predetermined direction, and the attenuation loss in the reflected telecommunication signal is less than a predetermined threshold (0.1 dB/mm at the desired 5G frequency). The desired reflectance is caused because of the use of reflectors 210 of particular dimension and material with high reflectance and low absorption of the telecommunication signal 104 in a predetermined frequency range, e.g., 5G telecommunications frequency.

In an example, the array 810 of reflectors 210 is made of an array of metallized patterns that are directly printed on the back side (the side attached to the wall surface) of the surface covering 408. Alternatively, the array 810 is made of an array of metallized patterns that is printed on a flexible substrate, which is laminated on the back side of the surface covering 408. Other examples of the surface covering 408 are also possible.

Each reflector 210 is a passive reflector that does not require a power source. It should be noted that the reflector 210 is coupled with the reflection panel 102 using several techniques such as lamination, printing, etching, and others described herein. The coupling can be performed at the time of manufacturing the reflection panel 102, or after the reflection panel 102 has been installed in the building 101. In an example, the reflector(s) 210 are printed on one or more layers of the surface covering 408 sheet or etched on a layer, such as a copper film, which is laminated on the surface covering 408. The layer with the reflectors 210 can be the first side 202, or the second (back) side 204, and the printing or etching is performed at the time of manufacturing the reflection panel 102. Alternatively, the reflection panel 102 is manufactured with the reflector(s) 210 printed on the first side 202 or the second side 204. For example, the reflector(s) 210 are printed or etched on a dielectric surface. In such cases, the first side 202 and the second side 204 are made using the dielectric material, such as porcelain (ceramic), mica, glass, plastics, and the oxides of various metals, fabric/non-woven substrate, and other such material that facilitates additive manufacturing.

In an example, the reflector 210 is coupled with the reflection panel 102 by laminating the reflector 210 on the reflection panel 102. The position and the number of the reflectors 210 on the reflection panel 102 is determined based on the environment in which the reflection panel 102 is located, and the target area. For example, the position of the reflector 210 is determined to facilitate the reflected telecommunication signal 105 to reach the CPE 110 in the target area based on an open space, for example, a doorway, a window, etc. through which the reflected telecommunication signal 105 can travel. The reflector 210 can further be coupled to the reflection panel 102 based on the position of the antenna 106 and the position of the CPE 110. For example, based on the position of the antenna 106 and the position of the CPE 110, the reflection path 130 is determined. The reflector 210 is added to the reflection panel 102 at a position where the telecommunication signal 104 will be incident on the reflection panel 102, so that the reflected telecommunication signal 105 is directed to the target area where the CPE 110 is positioned (or expected to be positioned).

A surface covering 408 that is embedded with the reflector(s) 210 is coupled with the reflection panel 102 at the determined position. For example, the surface covering 408 is coupled by laminating the surface covering 408 on the reflection panel 102. Alternatively, the surface covering 408 can be nailed, screwed, hung, or attached to the reflection panel 102 in any other manner.

In another embodiment of the invention, the position of the surface covering 408 on the reflection panel 102 is based on a predetermined location/area in the environment where the strength of the telecommunication signal 104 from the antenna 106 is below a predetermined threshold. For example, a mapping of the strength of the telecommunication signal 104 from the antenna 106 in the environment, and particularly the target area can be performed prior to adding the reflectors (210) to the reflection panel 102. The mapping reveals an area where the strength of the telecommunication signal 104 is below a predetermined threshold, for example, −100 dBm, −120 dBm, or any other such value. The position on the reflection panel 102 is then determined to direct the reflected telecommunication signal 105 to that area (i.e., the target area) where the strength of the telecommunication signal 104 is below the predetermined threshold. Accordingly, the strength of the telecommunication signal in the target area increases.

In accordance with aspects of the invention, the reflection panel 102 described herein improves the signal strength in the target area, and in turn, improves the quality of communication provided by the telecommunication signal 104. Embodiments of the invention described herein provide a practical application by facilitating one or more reflectors to be embedded with a reflection panel to enhance the signal strength/reach of the telecommunication signal. Further, embodiments of the invention described herein facilitate positioning the reflectors on the reflection panel 102 dynamically based on the structure of the building 101. For example, the positioning and number of the reflectors 210 can be based on a position of the antenna 106 (i.e., source of telecommunication signal), a position of a CPE 110 (i.e., destination of telecommunication signal), an area where the signal strength is to be improved, an opening, and so on. The reflection panel 102, accordingly, addresses a technical problem of a loss in signal-strength of the telecommunication signal 104. Although such technical challenges are experienced indoors and outdoors, such challenges are particularly pronounced indoors. The reflection panel 102 facilitates the use of one or more reflector arrays 810 within the built environment, (i.e. indoors and outdoors) without the need for wires and other antennas in the environment, to improve the signal-strength of the telecommunication signal 104.

In addition to enhancing the signal strength of the telecommunication signal 104, the reflection panel 102 can be used for other functions. For example, the reflection panel 102 is used as a touch interactive panel in an example.

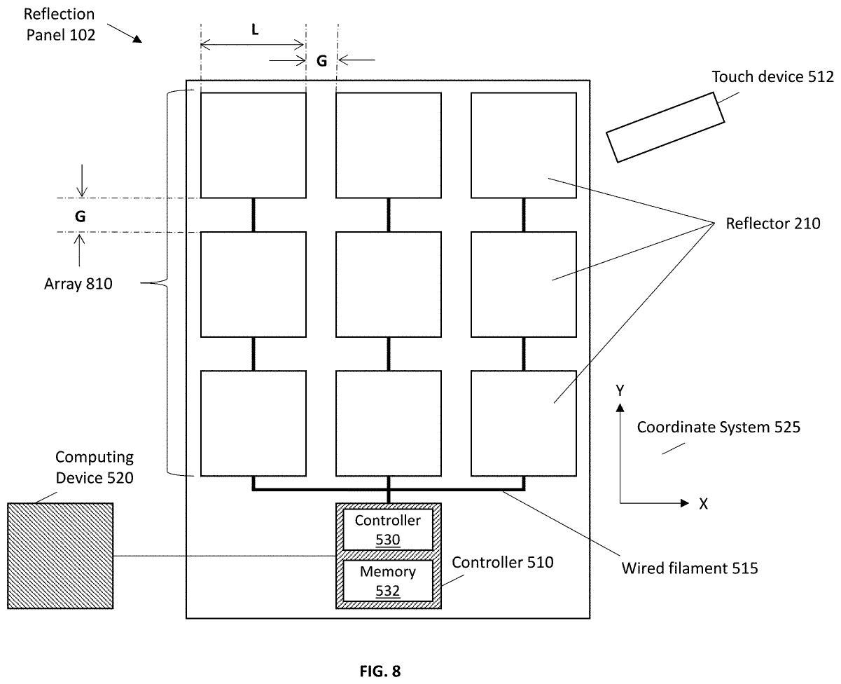

FIG. 8 depicts a block diagram of a reflection panel 102 that facilitates touch interaction capabilities according to one or more embodiments of the invention. FIG. 8 shows a front view of the reflection panel 102. The reflection panel 102 includes the array 810 of multiple reflectors 210. The reflectors 210 can be on the first side 202 or the second side 204 of the reflection panel 102. It is understood that the number of reflectors 210 in other embodiments of the invention can vary from those shown here. In addition, the reflection panel 102 includes a controller 510. The controller 510 can be embedded in the reflection panel 102 in an example. The controller 510 is coupled with the reflectors 210, in an example, using wired filaments 515. The controller 510 can be coupled with a computing device 520 in a wired or a wireless manner.

The controller 510 includes at least one processor 530 and a memory device 532. The processor 530 can execute one or more computer executable instructions, which may be stored in the memory device 532. The memory device 532 can store additional information that is used during execution of the computer executable instructions. In one or more embodiments of the invention, the controller 510 is coupled to the reflection panel 102 at a predetermined position, such as a port at which the wired filaments 515 of the reflectors 210 terminate. Accordingly, the controller 510 are coupled with the reflectors 210 via the wired filaments 515.

The controller 510 communicates signals to/from the reflectors 210 via the wired filaments 515. The controller receives one or more signals from the reflectors 210 when a touch device 512 contacts the reflectors 210. The controller 510, based on these signals, detects when and where the touch device 512 is contacted with the reflection panel 102. The controller 510 determines coordinates of the point of contact of the touch device 512 with the reflection panel 102. The coordinates are in a coordinate system 525 associated with the reflection panel 102. The coordinate system 525 can be a predetermined coordinate system.

The touch device 512 can be a finger, a pointer, a touch-pen, or any other device or a combination thereof. In an example, an image may be displayed on the reflection panel 102. The image can be displayed using the controller 510 in an example. Alternatively, the image can be projected on the reflection panel 102 using a projector (not shown) or any other device. The touch device 512 can be brought in contact with the reflection panel 102 to interact with the image.

The controller 510 can determine the coordinates of contact the touch device 512 based on resistive, capacitive, or any other techniques. The resistive panel 102 can include support circuitry (not shown) to facilitate such detection and determination. For example, in case the reflection panel 102 uses resistive techniques, the contact of the touch device 512 with a reflector 210, causes a change in electrical resistance of the area of that reflector 210. In an example, the support circuitry periodically transmits an electrical signal across the reflectors 210. The controller 510 monitors the electrical signal being transmitted across the reflectors 210. The change in the electrical resistance caused by the touch device 512 facilitates the controller 510 to identify the reflector 210 that was contacted by the touch device 512, and in turn determine coordinates of the contact. In the case of using the capacitive techniques, the contact by the touch device 512 causes a change in the capacitance of the area of the reflector 210 that is contacted, and subsequently, the coordinates are detected by the controller 510.

The coordinates that are detected are communicated to the computing device 520. The computing device 520 can use the coordinates for one or more functions, such as interaction with an image displayed on the reflection panel 102. Alternatively, or in addition, the coordinates are used to perform one or more operations such as controlling lighting, music, home devices in the building 101, or any other such operations. The reflection panel 102, accordingly, provides an interactive panel for the computing device 520, in an embodiment of the invention.

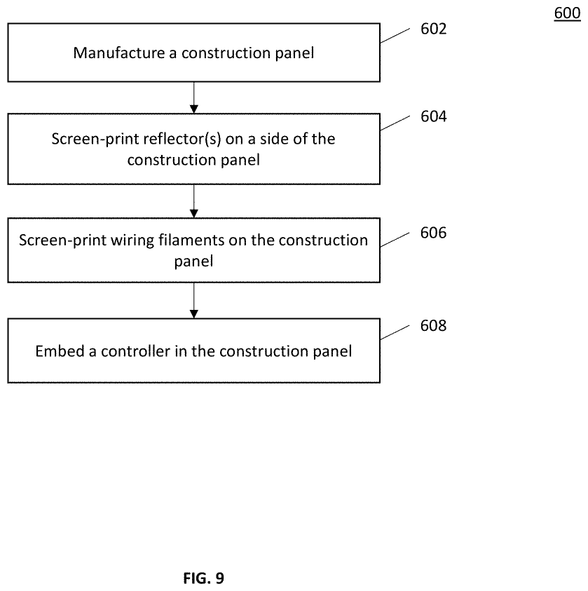

FIG. 9 depicts a flowchart for manufacturing a reflection panel according to one or more embodiments of the invention. The method 600 includes manufacturing a construction panel, at block 602. The construction panel can be a drywall, glass, wood, Styrofoam, sandwich panel, low emittance (low-E) insulated glass, and other panels used for walls, windows, decorative items, furniture, etc. Further, at block 604, the reflector(s) 210 are formed on the front side of the construction panel, the front side being the side of the construction panel that faces the target area. The reflector(s) 210 are formed using a predetermined pattern. The reflector(s) 210 are screen-printed using materials having high reflectance characteristics. Further, the front side 202 of the construction panel, with the reflectors, is covered with the surface covering 408. The surface covering 408 facilitates low absorption (below a predetermined threshold, e.g., 0.1 dB/mm) of the telecommunication signal 104. The characteristics of the reflectors 210 and the surface covering 408 facilitate the attenuation loss of the reflection panel 102 substrates to be less than a predetermined threshold, such as 0.1 dB. Examples of material used for the surface covering include, but are not limited to, Tedlar®, Tedlar®/PET, or any other combination of materials that includes Tedlar®. In one or more embodiments of the present invention, the reflectors 210 are added to the construction panel using additive manufacturing techniques such as, printing, plating, lithography, etc. Alternatively, the reflectors are formed using subtractive manufacturing techniques such as milling, lithography, etching, etc.

In an embodiment of the invention, at block 606, wired filaments 515 are formed, e.g., screen-printed, plated on the surface covering 408 to facilitate coupling the reflector(s) 210 with the controller 510. The wired filaments 515 can be copper, aluminum, or any other conductive material. In one or more embodiments of the present invention, the wired filaments 515 are formed on the printing layer 414. Alternatively, the wired filaments 515 are formed on the fabric/non-woven substrate layer 418.

Further, at block 608, the controller 510 is embedded in the construction panel. The controller 510 is embedded using CNC milling and sealed in an embodiment of the invention. Alternatively, the controller 510 is embedded using other techniques, such as adhering a controller to the construction panel, for example, using an adhesive, screws, nails, or any other adherent. In one or more embodiments of the present invention, the controller 510 can be formed in the surface covering 408.

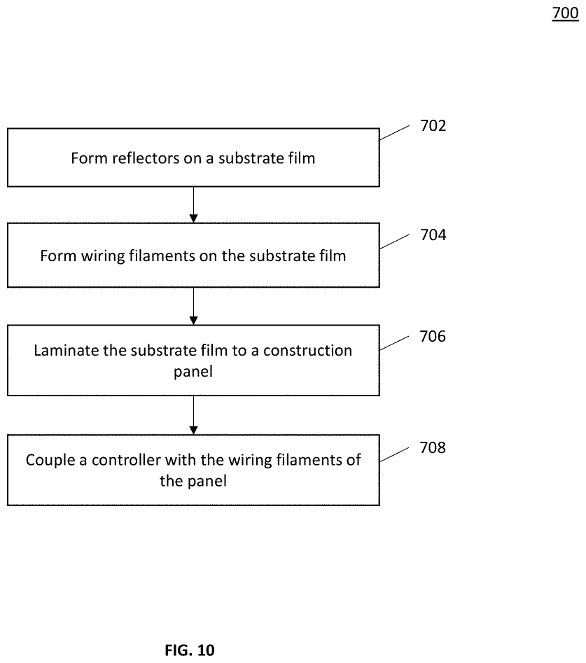

FIG. 10 depicts a flowchart for manufacturing a reflection panel according to one or more embodiments of the invention. The method 700 includes forming the reflector(s) 210 on a pre-defined substrate film using printing or etching, at block 702. In an embodiment of the invention, the wired filaments 515 are also formed on the substrate film using printing or etching, at block 704. The wired filaments 515 facilitate connecting the reflector(s) 210 with the controller 510. The substrate film, with the reflector(s) 210 is further laminated to a construction panel to form the reflection panel 102, at block 706. The controller 510 is coupled with the wired filaments 515 of the reflection panel 102, at block 708. The controller 510 is embedded using CNC milling and sealed in an embodiment of the invention. Alternatively, the controller 510 is embedded using other techniques, such as adhering a controller to the construction panel, for example, using an adhesive, screws, nails, or any other adherent.

In one or more embodiments of the present invention, the substrate film is made of PET, Tyvek®, Kapton®, or other such low absorption loss material on which the reflectors 210 are printed or formed using any other additive manner. Alternatively, the substrate film includes a copper coated film on any of the low absorption loss film substrates on which the reflectors 210 are etched, milled, or formed in any other subtractive manner. The substrate film with the reflectors 210 formed on it is adhered to the reflection panel 102. Alternatively, the substrate film with the reflectors 210 is adhered to the surface covering 408, which in turn is adhered to the reflection panel 102. In one or more embodiments of the present invention, the substrate film is adhered to the back side of the surface covering 408, i.e., on the side that is adjacent to the surface 402 and is opposite from the target area. In one or more embodiments of the present invention, the substrate film is the surface covering 408.

It should be noted that in some embodiments of the invention, the etching in the method 700 can be performed after laminating the substrate film to the construction panel. In another embodiment of the invention, the printing/etching is performed first, and then the substrate film is laminated on the construction panel.

In an embodiment of the invention, the substrate film that is etched, is made using materials having low attenuation loss characteristics including but not limited to low absorption. Examples of such material include, but are not limited to, Tedlar®, Tedlar®/PET, or any other combination of materials that includes Tedlar®. Alternatively, in another embodiment of the invention, the substrate film is of any other material, such as thermoplastic etc., on which the reflector(s) 210 are printed using Tedlar®, Tedlar®/PET, or any other combination of materials that includes Tedlar®.

The construction panel that is constructed using any of the methods described herein is then used to construct the building 101 as a reflection panel 102. Alternatively, or in addition, the construction panel is used to build other objects such as paintings, screens, doors, windows, etc. The reflection panel 102 and/or the objects made of the reflection panel 102 are placed at a position that is determined to facilitate directing the telecommunication signal 104 to the CPE 110 in the target area.

Embodiments of the invention described herein provide an improvement to propagating telecommunication signals to a target area by providing panels that reduce attenuation loss caused during reflection of telecommunication signals that are incident on such panels. Such a panel includes a base sheet, and at least one reflector on a side of the base sheet. The reflector reflects a telecommunication signal that is of a predetermined wavelength and that is incident on the base sheet. A reflected telecommunication signal that is caused is reflected in a predetermined direction by the reflector. The attenuation loss in the reflected telecommunication signal is less than a predetermined threshold because of the characteristics of the material used for the formation of the reflector and the pattern dimension. Such characteristics include high reflectance and low absorption.

In addition, the panel can provide a user interactive surface, for example, via touch-sensitivity, to further increase the utility of the area on which the panel is fixed.

In one or more embodiments of the invention, a computer readable storage medium can store computer executable instructions, which when executed by one or more processing units, cause the one or more processing units to perform a method described herein.

In the present description, the terms “computer program medium,” “computer usable medium,” “computer program product,” and “computer readable medium” are used to generally refer to media such as memory. Computer programs (also called computer control logic) are stored in memory. Such computer programs, when run, enable the computer system to perform the features of the present invention as discussed herein. In particular, the computer programs, when run, enable the controller to perform the features and operations described herein. Accordingly, such computer programs can controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Many of the functional units described in this specification have been labeled as modules. Embodiments of the present invention apply to a wide variety of module implementations. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, comprise the module and achieve the stated purpose for the module.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

The terminology used herein is for the purpose of describing particular embodiments of the invention only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The phrases “in signal communication, “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A panel comprising:
a base sheet;
a reflector on a side of the base sheet, the reflector reflects a telecommunication signal that is of a predetermined wavelength and that is incident on the base sheet, wherein a reflected telecommunication signal is reflected in a predetermined direction, and the attenuation loss in the reflected telecommunication signal is less than a predetermined threshold.

2. The panel of claim 1, wherein the reflector comprises a plurality of reflectors.

3. The panel of claim 1, wherein the telecommunication signal is incident on a first side of the base sheet, and the reflector is on a second side of the base sheet, the second side being opposite to the first side.

4. The panel of claim 1, wherein the reflector is made of an array of metallized patterns that are directly printed on a surface covering.

5. The panel of claim 1, wherein the reflector is made of an array of metallized patterns that is printed on a flexible substrate, which is laminated on a surface covering.

6. The panel of claim 1, wherein the reflector is a passive reflector that does not require a power source.

7. The panel of claim 1, wherein the reflector is coupled with the base sheet.

8. The panel of claim 7, wherein the reflector is coupled with the base sheet by laminating the reflector on the base sheet.

9. The panel of claim 2, wherein the positions and number of reflectors are determined based on an environment in which the panel is located, wherein the position is determined based on:
a location of a telecommunication antenna that provides the telecommunication signal that is incident on the reflectors, and
a location of a computing device that receives the telecommunication signal from the reflectors.

10. The panel of claim 2, wherein the positions and number of reflectors are determined based on an environment in which the panel is located, wherein the positions are determined based on:
a location of a telecommunication antenna that provides the telecommunication signal that is incident on the reflectors, and
a predetermined location/area in the environment where the strength of the telecommunication signal is below a predetermined location.

11. The panel of claim 1, wherein the telecommunication signal is a 5G signal.

12. The panel of claim 1, further comprising:
a controller coupled with the reflector, and wherein the controller is configured to perform a method comprising:
in response to a user touching the reflector with a predetermined object, determining coordinates of a position at which the object touches the reflector, the coordinates are in a frame of reference of the reflector; and
outputting the coordinates that are determined.

13. The panel of claim 1, wherein the opposite side is facing a target area.

14. A method to manufacture a panel, the method comprising:
manufacturing a construction panel; and
screen-printing a reflector on one side of the construction panel, the reflector is made using a material that has at least a predetermined reflectance and at most a predetermined absorption of the telecommunication signal.

15. The method of claim 14, further comprising, screen-printing a plurality of wired filaments on the construction panel, the wired filaments connecting the reflector to a controller.

16. The method of claim 15, further comprising, coupling the controller to the construction panel.

17. A method to manufacture a panel, the method comprising:
forming, on a substrate film, one or more reflectors, wherein the one or more reflectors include metallized patterns, and the substrate is made from a material has at most a predetermined absorption of the telecommunication signal; and
laminating the substrate film on a construction panel.

18. The method of claim 17, wherein the one or more reflectors are formed using etching.

19. The method of claim 17, wherein the one or more reflectors are printed on the substrate film to form the metallized patterns.

20. The method of claim 17, wherein the substrate film is laminated on a first side of the construction panel, wherein a telecommunication signal is expected to be incident on a second side that is opposite to the first side.
